(19) United States
(12) Patent Application Publication
(10) Pub. No.: US 2004/0000745 A1
(43) Pub. Date: Jan. 1, 2004

(54) Moulding of composite materials

(76) Inventor: Kevin John Channer, Coventry (GB)

Correspondence Address: Doyle B. Johnson, REED SMITH CROSBY HEAFEY, P.O. Box 7936, San Francisco, CA, 94120-7936, US

(21) Appl. No.: 10/336,139

(22) Filed: Jan. 3, 2003

Related U.S. Application Data
(63) Continuation of application No. PCT/GB01/02920, filed on Jun. 29, 2001.

(30) Foreign Application Priority Data
Jul. 4, 2000 (GB) GB 0016269.3

(51) Int. Cl. B29C 70/48

(52) U.S. Cl. 264/511; 264/257; 264/316; 425/387.1

(57) ABSTRACT

Apparatus for moulding composite materials comprises a frame (8) holding the margins of a pair of elastomeric membranes (4, 5) substantially in a plane in facing relationship. The frame (8) is secured within a moulding chamber formed by upper and lower sections (1, 2) respectively to divide the moulding chamber into a mould side MS which contains a mould form (9) and an opposite side OS. A jack diagrammatically illustrated at (13) is provided for effecting relative movement between the frame and the mould form (9) in the direction generally perpendicular to the plane of the frame. A resin introduction port (19) is provided for introducing resin between the membranes (4, 5) at a central region Ducting (11) is provided for aspirating the inter-membrane space, and inlet ducts OSI and MSI and outlet ducts OS2 and MS2 are provided for respectively pressurising and aspirating the mould opposite side OS and the mould side MS of the moulding chamber. To be accompanied, when published, by FIG. 1 of the drawings.

This invention relates to a method of and apparatus for the moulding of composite materials.

There are many methods known for the moulding of composite materials. These range from purely manual, labour intensive methods, such as hand laminating, and vacuum bagging with autoclave processing, to semi-automated processes such as resin transfer moulding (RTM). Currently the processing method is chosen to suit the required composite properties and volumes required. For example in the hand laminating process it is difficult to control the fibre fraction and orientation and that process is therefore used for the low volume production of non-structural parts. In contrast, the vacuum bagging/autoclave processing of pre-impregnated directional fabrics (prepreg) which may be based on carbon or other fibres, produces high fibre volume, low void components suitable for low volume aerospace applications. RTM can be used to process both random and directional fabrics (directional fabrics at lower fibre fractions) at higher volumes, but RTM often requires a second set of preforming tools. This process is often used in the automotive industry. Hand laminating and vacuum bagging/autoclave processes both require labour intensive hand placement of the fibres. In addition, all these processes require the tool surface to be polished and to be prepared with a mould releasing agent before the fibres are presented to the tool surface.

The diaphragm forming of thermoplastic or thermosetting matrix prepreg is well known. In this process, the prepreg is placed between two diaphragms, usually made from a high temperature polyimide plastic. A vacuum is drawn between these diaphragms and the matrix heated, for one hour, to reduce the viscosity (300 Pas at 300° C.) to allow the fibres to move freely during forming. The diaphragms provide biaxial tension that suppresses fibre wrinkling and buckling during the forming stage of the process. This forming process requires an autoclave vessel because of the rather high pressure (about 1 MPa) that may be needed to facilitate the compliance of the fibres to the required mould shape.

It is known to mitigate the disadvantages of the above composite manufacturing systems by sandwiching the. dry fibres between a. pair of elastomeric diaphragms and infusing the resin before reducing air pressure on one side of the sandwich so that the now wet fibres are urged against a single former by for example atmospheric pressure on the other side of the membrane. Both random and directional fibres can be processed in this way. The mould surface is unprepared.

The present invention is based on research into moulding practices in an endeavour to find a technique which is appropriate for use for manufacturing single articles and also for series production runs, and which offers certain other advantages over the known methods.

According to the present invention, there is provided apparatus for moulding composite materials which comprises a frame for holding the margins of a pair of elastomeric membranes in facing relationship substantially in a plane, the frame being securable within a moulding chamber to divide that chamber into a mould side which contains a mould form and an opposite side, means for effecting relative movement between the frame and the mould form in a direction generally perpendicular to the plane of the frame, means for aspirating the inter-membrane space, means for introducing resin between the membranes at a central region thereof, and aspirating means and pressurising means for independently effecting pressure changes in the mould side and the opposite side of the moulding chamber.

The invention also provides a method of moulding composite materials which comprises laying up a pre-cut web of fibre reinforcement and sandwiching it between a pair of elastomeric membranes, holding the sandwich together at its margin in a moulding chamber to divide that chamber into a mould side and an opposite side, aspirating the inter-membrane space, applying positive pressure to the mould side and the opposite side of the chamber to hold the membranes together, introducing resin prepolymer through a first one of said membranes into a central region of the reinforcement web and causing or allowing that resin prepolymer to flow radially to substantially the full extent of the web, applying a pressure differential across the membrane sandwich to impart to the sandwich a convexity in the same sense as a mould form in the moulding chamber, bringing the mould and the membrane sandwich into contact and applying fluid pressure to urge the membranes and sandwiched web reinforcement into conformity with the mould form and causing or allowing the resin to cure.

The adoption of the invention offers a numbers of advantages.

The apparatus is greatly simplified as compared with known series production apparatus, since there is no need for hand lay-up or a pre-forming tool, and while a secondary mould die may be used if desired, only a single, primary, mould die is normally needed for the moulding step. If used, such a secondary die may be of a size matching the primary, or one or more smaller secondary dies may be used for exerting local pressure on the membrane sandwich to urge it against the primary die. The need for heating apparatus for softening a thermoplastic or thermosetting matrix of a prepreg is avoided. The equipment required for performing the invention can be of low capital cost because of the low forming pressures which may be used compared to conventional autoclave processing, and lower tooling costs compared to RTM.

A wide variety of products may be manufactured using the method and apparatus of the invention. Among such products are vehicle body panels, sailing boats, structural components such as chassis. Such products may often be regarded as having an interior side and an exterior side, and they are typically generally. concave, perhaps with one or more local convexities, or generally convex, possibly with one or more local concavities, depending on the viewpoint. We have found that it is usually more convenient to make use of a said mould form which is generally convex. This makes it easier to bring the membrane sandwich into conformity with the mould form, and in particular it promotes an easy drape of the pre-cut web over the mould form, in turn promoting an easy and easily reproducible lay-up of that web.

Laying up of the fibre reinforcement web is very simple. Such web is simply applied to one of the membranes in a flat state and the other membrane is assembled and clamped thereto using the frame. Due to the pressure differential between the inter-membrane space and the air and mould sides of the moulding chamber, the reinforcement web is maintained in an appropriate unwrinkled condition during resin injection and assembly to the mould form, and the web thus forms an even drape over that form. It is thus very much more easy to mould rather complex shapes and to ensure that the fibres in the web are appropriately aligned over various parts of the mould form if that is desired. In the case where a web having oriented fibres is used, the optimum product performance is achieved when the fibres are aligned with lines of stress in the eventual product. This can be achieved more easily in a wrinkle free manner when the fibres are first laid up on a flat surface, as they may be in accordance with this invention, and thus a consistent repeatability may be achieved.

The invention may be put: into effect for prototyping or for series production at a low operating cost. Low fabric wastage is possible because the fabric can be cut to net-shape.

Any desired form of reinforcement web may be used appropriate to the properties sought in the product. The web may comprise a single layer, or plural layers in which case the layers may be of the same composition or structure or of different compositions and/or structures, and successive layers of a same composition and structure, for example layers of parallel fibres, may be laid with different orientations. Such a web layer may be a woven or non-woven mat, or it may be of unidirectional fibres. Continuous or chopped strand fibre may be used as desired. The fibres may be of glass, carbon or synthetic polymeric material such as KEVLAR™ (poly-para-phenylene terephthalamide) or natural vegetable material such as hemp, or metal fibres may be used, as appropriate.

Any of a wide variety of resins may be used, again depending on the properties sought in the product. Such resins include polyester resins, epoxy resins, vinyl esters and other engineering resins including liquid crystal materials whose use in this context is known per se. The viscosity of the resin prepolymer used is not critical and may be of the order of 300 mPas as is common in many previously known composite resin moulding systems, or it may be less, for example about 200 mPas. The complexity of filling the fibres is greatly simplified as the fibre is always flat during filling.

In addition to the fibrous reinforcement, the resin matrix may include any of a wide range of fillers depending on the properties required of the product. Such fillers may be of any required form, for example pigments may be incorporated into the resin matrix. In some embodiments of the invention, a core of foam material is incorporated.

The fluid acting to exert pressure on one face or the other of the membrane sandwich may be the same or different at the two sides of that sandwich. Preferably, the same fluid is used on both sides. The fluid used may be a liquid, but it is preferably a gas or gas mixture, and it is generally most convenient to use air.

Because the mould form is not in direct contact with the liquid resin prepolymer, the surface of the mould form does not need to be of the highest quality, for example it does not need to be polished. The mould surface does not need mould release as there is no contact between it and the composite. This contributes to the economy of the apparatus and process of the invention, and it allows the use of a mould form which is perforated, as is preferred.

The use of a perforated mould form allows aspiration of any space between the mould form and the membrane sandwich to draw that sandwich into close conformity with the surface of the mould form. This is a very convenient way of urging a resin-impregnated reinforcing web into a desired shape in which it may be caused or allowed to cure. To that end, means is preferably provided for drawing fluid through the mould form.

Advantageously, at least one said membrane is formed of silicone rubber. Silicone rubber has excellent mould release qualities and is highly elastic. It can also be transparent for allowing inspection of the moulding progress if that is wanted.

Preferably, the resin is introduced through a single membrane provided with one or more openings for that purpose, the other membrane being continuous. It is envisaged that the resin will usually be introduced through the membrane on the opposite side of the sandwich to the mould. This helps to avoid problems with moulding in of a discontinuity in the membrane at the resin introduction point. Even where there is a designed gap in the moulded article at a convenient location, for example the drain hole of a wash basin, which allows a corresponding hole in the mould through which a resin feed tube could be led, operational considerations make it more convenient to introduce the resin through the opposite membrane. It is accordingly preferred that the mould-side membrane be continuous.

In accordance with the invention, a said continuous membrane may be incorporated as an external layer in the moulded product. However, this will usually require that that layer be of a thermoplastic material

Advantageously, at least one of the facing surfaces of the membranes is figured. Such figuring can readily be adapted to provide airways assisting aspiration of the inter-membrane space and the drawing in of resin prepolymer and promoting its flow across a reinforcement web sandwiched between the membranes. In the most preferred embodiments of the invention, such figuring is substantially confined to the area of the pre-cut reinforcement web. Operating in this way helps to ensure that the web is completely and uniformly impregnated with resin prepolymer, while the spread of such prepolymer beyond the web boundary, and consequently waste of resin, is much reduced or eliminated.

In some embodiments of the invention, a random figuring is used, but in particularly preferred embodiments, such figuring is venose. The veins of such venose figuring may be arranged progressively to reduce in diameter from the centre to the periphery of the figured area, in accordance with the quantity of resin prepolymer which is required to pass any given point for a uniform (or other desired) distribution of resin in the web.

We have referred to the possible use of an autoclave in performing the process of the invention and have also mentioned the cost of such a device. It is usually preferred that the process is performed at ambient temperature, though a heated mould form or heated resin or a heated pressurising fluid (air, water) may be used if it is desired to accelerate curing.

A preferred embodiment of the invention will now be described with reference to the accompanying diagrammatic drawings in which:

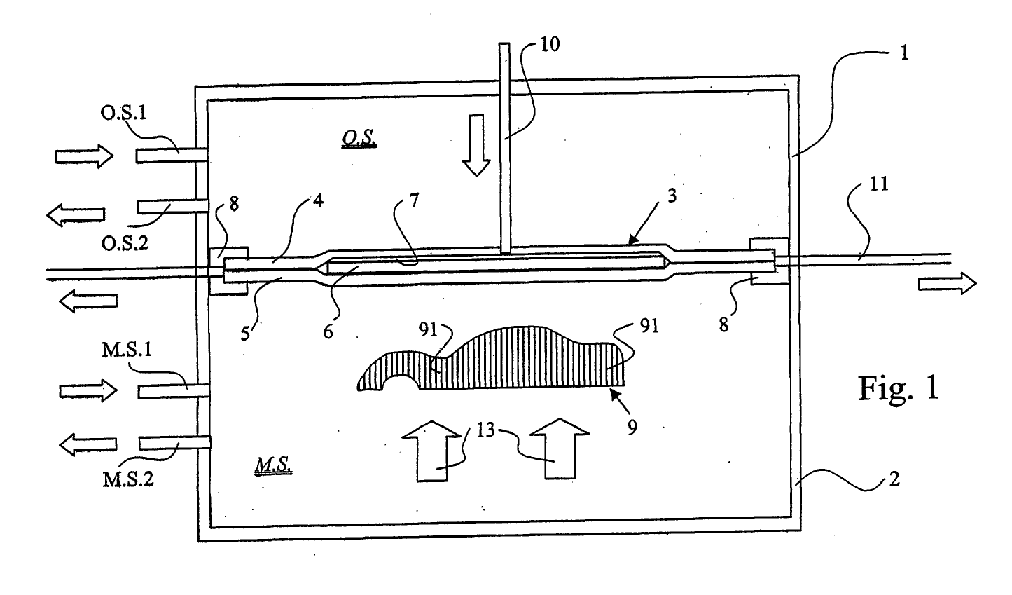

FIG. 1 is a diagrammatic view of a moulding chamber incorporating a membrane sandwich and a mould form for use in a method according to the invention;

FIG. 2 is a plan view of a pre-cut web of a fibre reinforcement for incorporation in the membrane sandwich in FIG. 1;

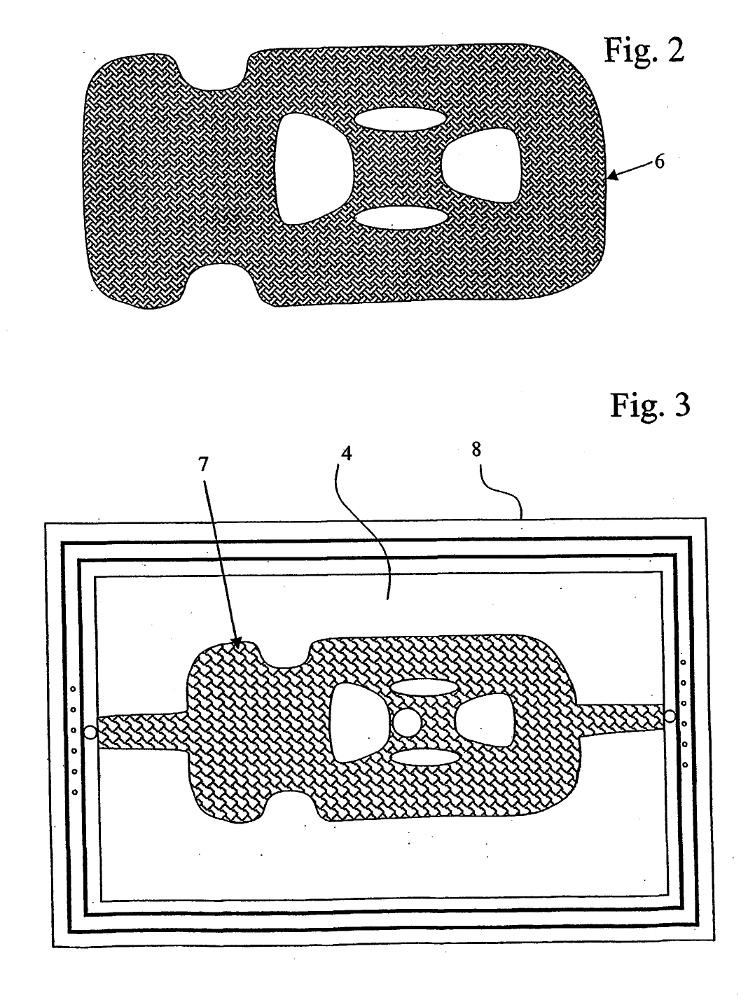

FIG. 3 is a plan view of one membrane of the sandwich;

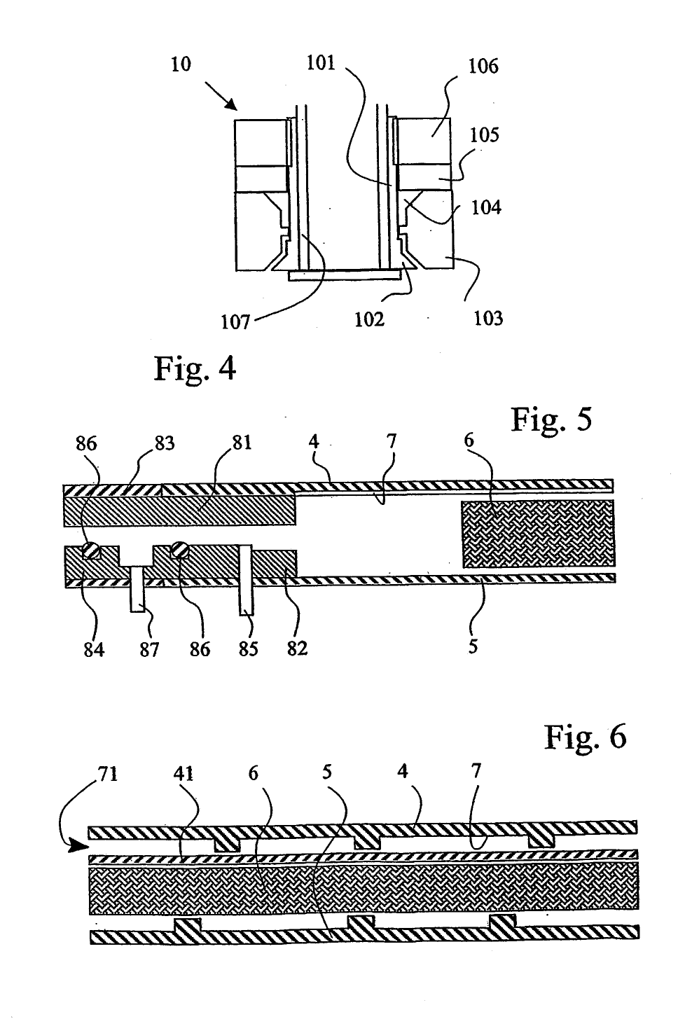

FIG. 4 is a cross-sectional view of means whereby resin may be introduced through the membrane of FIG. 3;

FIG. 5 is a detail of edge sealing of the membrane sandwich; and

FIG. 6 is a detail view of a modified membrane sandwich for use in a method according to the invention of.

In the drawings, apparatus for moulding composite materials comprises a frame 8 holding the margins of a pair of elastomeric membranes 4, 5 substantially in a plane in facing relationship. The frame 8 is secured within a moulding chamber formed by upper and lower sections 1, 2 respectively to divide the moulding chamber into a mould side MS which contains a mould form 9 and an opposite side OS. Means. such as a jack diagrammatically illustrated at 13 is provided for effecting relative movement between the frame 8 and the mould form 9 in the direction generally perpendicular to the plane of the frame. The precise nature of this jacking apparatus is not critical. Any convenient means for effecting such relative movement may be used.

Means 10 is provided for introducing resin between the membranes 4, 5 at a central region thereof and means 11 is provided for aspirating the inter-membrane space, and pressurising means OS1 and MS1 and aspirating means OS2 and MS2 are provided for respectively pressurising and aspirating the mould opposite side OS and the mould side MS of the moulding chamber.

The precise nature of the means for introducing resin between the membranes, of the means for aspirating the inter-membrane space, and the pressurising and aspirating means are not critical. Any convenient means may be used.

When performing the invention a pre-cut web 6 (see also FIG. 2) is laid up between the pair of elastomeric membranes 4, 5 to form a sandwich 3. The sandwich 3 is clamped together at its margin in a moulding chamber 1, 2 to divide that chamber into a mould side MS and an opposite side OS. The space between the membranes 4, 5 is aspirated and positive pressure is applied to the mould side MS and the opposite side OS of the chamber to hold the membranes 4, 5 and web 6 together as a sandwich 3. Resin prepolymer is introduced through a first one of said membranes into a central region of the reinforcement web 6 and is caused or allowed to flow radially to substantially the full extent of that reinforcement web 6.

In order to assist aspiration of the inter-membrane space occupied by the reinforcement web 6, and outward radial flow of the resin prepolymer when that is introduced, at least one of the membranes 4, 5 is provided with an area of figuring 7 which most preferably corresponds with the size and shape of the pre-cut web 6 of fibre reinforcement (compare FIGS. 2 and 3). Such figuring may be provided in various ways. For example, a random pattern of figuring may be used. As an alternative, the figuring may take a venose patterning. Veins such of a venose patterning are suitably arranged to taper down in diameter as they lead away from the zone of introduction of the resin in accordance with the quantity of resin prepolymer which is required to pass any given point for the desired. distribution of resin in the web. The figuring may be arranged differentially across the membrane. For example, the membrane may be rather heavily figured at its centre where resin prepolymer is introduced, and over the extent of the web 6, while outside the area of the pre-cut web 6 of reinforcing fibre there is a much lighter pattern of figuring, for example of veining which is sized appropriately for the aspiration of air rather that the distribution of a rather viscous liquid. Such a combination of figuring can promote aspiration of air from between the membranes and helps to ensure that the resin prepolymer occupies the entire area of the web 6 with a very low excess of resin being drawn beyond that area.

The figuring is preferably moulded into the membrane. However, it is within the scope of the invention to use a separate element for forming the figuring. Such a separate figuring element may be constituted by a sheet of cloth, for example, cut to the same size as the fibre web and which may be stripped from the moulding after the resin has cured.

By suitably adjusting the pressure in the moulding chamber on each side of the membrane sandwich 3 it is possible to ensure that the fibre web 6 remains clamped between the two membranes 4, 5 and also that the resin prepolymer can flow over not only the entire area but also through the entire thickness of that pre-cut web 6. The moulding pressure applied on both sides of the membrane allows positive injection to be balanced and combined with vacuum infusion. This enables the resin to penetrate high fibre loadings, which is not possible with vacuum infusion alone. This balanced injection promotes a very low population of voids within a resin composite moulding and thus is beneficial for its structural strength.

After the completion of resin prepolymer infusion, a pressure differential is introduced between the mould side MS and the opposite side OS of the moulding chamber. This may be done by aspirating or releasing pressure in the opposite side OS or by increasing pressure in the mould side MS, or both. The effect of this is to force the membrane sandwich 3 to form a downwardly concave, upwardly convex shape which brings it into approximate conformity with the generally upwardly convex mould form 9. Aspiration of the inter-membrane space is maintained and the effect of this is to ensure that the pre-cut web of fibre 6 remains clamped and thus held in tension within the sandwich 3. The mould form 9 is then raised using the jack 13 to nest it against the lower concave side of the membrane sandwich 3. At this stage pressure in the mould opposite side OS may be increased and pressure in the mould side MS may be reduced. Such a pressure gradient across the membrane sandwich 3 urges the sandwich into conformity with the mould form 9. And the reduction in pressure in the mould side MS causes downward aspiration through air ways 91 provided in the mould form 9 for that purpose. The net effect of this is to provide a downward pressure on the membrane sandwich 3 forcing it into conformity with the surface of the mould form 9. This in turn brings the pre-cut web reinforcement 6 into conformity with the mould form 9 and because the web 6 is held in tension within the sandwich 3 it is constrained to adopt the form of the mould form 9 with a very low tendency to any wrinkling.

The process may be performed at ambient temperature, that is to say, it is not necessary to provide heat to the system or to remove heat from it.

A suitable attachment 10 for connecting a resin introduction line through a membrane is shown in FIG. 4. This attachment comprises a hollow bolt 101 having a conical clamping head 102 which co-operates with a profiled clamping ring 103 to hold captive a section of the membrane such as the margin of the resin introduction hole 90 of FIG. 3. A conical sealing ring 104 is clamped into the profiled clamping ring 103 using washer 105 and nut 106 on the bolt 101. The hollow bolt 101 is suitably lined with a liner 107 of polytetrafluoroethylene.

As diagrammatically represented in FIG. 5, the membranes 4, 5 are adhesively bonded to the outside of upper and lower frame members 81, 82 e.g. using strips of adhesive 83, 84 after assembly of the membranes 4, 5 about a pre-cut reinforcing web 6. Figuring 7, see also FIG. 3 leads to the inner edge of the frame 8 and assists in the aspiration of air from the inter-membrane space via exhaust duct 85 provided in the lower frame member 82, thus also promoting the radially outward flow of resin from a central introduction point 90 (FIG. 3) into the reinforcement web 6, over the full extent of the reinforcement web 6. A vacuum guard is provided by two ‘O’ rings 86 enclosing the mould area. A second vacuum is applied between these via exhaust outlets such as 87. This reduces the pressure differential across each of the O-rings 86 which separate the vacuum inside the membrane sandwich and atmospheric pressure outside, and so makes maintenance of that vacuum easier. The two chambers of the mould sit on above and below the frame members 81, 82, and they may be sealed to the frame with conventional sealing means such as a single O-ring.

FIG. 6 illustrates a further embodiment of the invention in which a smooth elastomeric membrane 41 is interposed between the upper membrane 4 and the pre-cut web 6. As a result of the figuring 7 on the upper membrane 4, an inter-membrane space 71 is created. In the moulding process, this inter-membrane space 71 is aspirated so that the smooth membrane 41 conforms to the figuring 7 of the upper membrane 4. Resin is then introduced as described above, and the web is urged into conformity with the mould form 9 (FIG. 1). Pressure in the inter-membrane space 71 is increased with the pressure in the opposite side OS of the moulding chamber so that the smooth membrane 41 comes out of conformity with the figuring 7 in the top membrane 4. This promotes the formation of a smooth unfigured surface for the moulded article.

The smooth membrane, like the membranes 4, 5, is suitably formed from a silicone rubber. The medium used for varying the pressure in the inter-membrane space 71 may be the same as, or different from, the medium used for applying pressure externally of the sandwich. It is particularly suitable to use a liquid for exerting pressure within the inter-membrane space 71.

1. Apparatus for moulding composite materials which comprises a frame for holding the margins of a pair of elastomeric membranes in facing relationship substantially in a plane, the frame being securable within a moulding chamber to divide that chamber into a mould side which contains a mould form and an opposite side, means for effecting relative movement between the frame and the mould form in a direction generally perpendicular to the plane of the frame, means for aspirating the inter-membrane space, means for introducing resin between the membranes at a central region thereof, and aspirating means and pressurising means for independently effecting pressure changes in the mould side and the opposite side of the moulding chamber.

2 Apparatus according to claim 1, wherein the mould form is generally convex.

3 Apparatus according to claim 1 or 2, wherein said aspirating means and said pressurising means for independently effecting pressure changes in the mould side and the opposite side of the moulding chamber are adapted for use with air.

4 Apparatus according to any preceding claim, wherein said mould form is perforated.

5 Apparatus according to claim 4, wherein means is provided for drawing fluid through the mould form.

6 Apparatus according to any preceding claim, wherein at least one said membrane is formed of silicone rubber.

7 Apparatus according to any preceding claim, wherein one said membrane is provided with one or more openings for introducing resin, the other membrane being continuous.

8 Apparatus according to any preceding claim, wherein the opposite side membrane is provided with one or more openings for introducing resin.

9 Apparatus according to claims 7 and 8, wherein the mould-side membrane is continuous.

10 Apparatus according to any preceding claim, wherein at least one of the facing surfaces of the membranes is figured.

11 Apparatus according to claim 10, wherein such figuring is venose.

12 Apparatus according to claim 11, wherein the veins of such venose figuring are arranged progressively to reduce in diameter from the centre to the periphery of the figured area.

13 Apparatus according to any preceding claim. Wherein a heater is provided for heating the mould form, and/or the resin and/or the pressurising fluid.

14 A method of moulding composite materials which comprises laying up a pre-cut web of fibre reinforcement and sandwiching it between a pair of elastomeric membranes, holding the sandwich together at its margin in a moulding chamber to divide that chamber into a mould side and an opposite side, aspirating the inter-membrane space, applying positive pressure to the mould side and the opposite side of the chamber to hold the membranes together, introducing resin prepolymer through a first one of said membranes into a central region of the reinforcement web and causing or allowing that resin prepolymer to flow radially to substantially the full extent of the web, applying a pressure differential across the membrane sandwich to impart to the sandwich a convexity in the same sense as a mould form in the moulding chamber, bringing the mould and the membrane sandwich into contact and applying fluid pressure to urge the membranes and sandwiched web reinforcement into conformity with the mould form and causing or allowing the resin to cure.

15 A method according to claim 14, wherein a single, primary, mould die is used for the moulding step.

16 A method according to claim 14, wherein one or more smaller secondary dies is or are used for exerting local pressure on the membrane sandwich to urge it against the primary mould die.

17 A method according to any of claims 14 to 16, wherein the (primary) mould form is generally convex.

18 A method according to any of claims 14 to 17, wherein the fibre reinforcement web is applied to one of the membranes in a flat state and the other membrane is assembled and clamped thereto using the frame.

19 A method according to any of claims 14 to 18, wherein the reinforcement web fibres are of glass, carbon or synthetic polymeric material or natural vegetable material such as hemp, or metal fibres.

20 A method according to any of claims 14 to 19, wherein the resin used is selected from: polyester resins, epoxy resins, vinyl esters and other engineering resins including liquid crystal materials.

21 A method according to any of claims 14 to 20, wherein the fibre is held flat during filling.

22 A method according to any of claims 14 to 21, wherein, in addition to the fibrous reinforcement, the resin matrix includes any further filler material.

23 A method according to any of claims 14 to 22, wherein the same fluid is used to exert pressure on both sides of the membrane sandwich.

24 A method according to any of claims 14 to 23, wherein the fluid used to exert pressure on the membrane sandwich is a gas or gas mixture, such as air.

25 A method according to any of claims 14 to 24, wherein the mould form is perforated.

26 A method according to claim 25, wherein any space between the mould form and the membrane sandwich is aspirated through the mould form to draw that sandwich into close conformity with the surface of the mould form.

27 A method according to any of claims 14 to 26, wherein the resin is introduced through a single membrane provided with one or more openings for that purpose, the other membrane being continuous.

28 A method according to any of claims 14 to 27, wherein the resin is introduced through the membrane on the opposite side of the sandwich to the mould.

29 A method according to any of claims 14 to 28, wherein at least one of the facing surfaces of the membranes is figured.

30 A method according to claim 29, wherein such figuring is adapted to provide airways assisting aspiration of the inter-membrane space and the drawing in of resin prepolymer and promoting its flow across a reinforcement web sandwiched between the membranes.

31 A method according to claim 29, wherein such figuring is substantially confined to the area of the pre-cut reinforcement web and to discrete airways extending radially therefrom.

32 A method according to claim 29 or 30 or 31, wherein such figuring is venose.

33 A method according to claim 32, wherein the veins of such venose figuring are arranged progressively to reduce in diameter from the centre to the periphery of the figured area, in accordance with the. quantity of resin prepolymer which is required to pass any given point for a uniform (or other desired) distribution of resin in the web.

34 A method according to any of claims 14 to 33, wherein the process is performed at ambient temperature.

35 A method of moulding composite materials substantially as herein described with reference to any of the accompanying diagrammatic drawings.

36 Apparatus for moulding composite materials substantially as herein described with reference to any of the accompanying diagrammatic drawings.
